(19) United States
(12) Patent Application Publication
(10) Pub. No.: US 2006/0093719 A1
(43) Pub. Date: May 4, 2006

(54) Particulate ice cream dot sandwich

(75) Inventor: Anne Nelson, Paducah, KY (US)

Correspondence Address: STOCKWELL & ASSOCIATES, PSC, 861 CORPORATE DRIVE, SUITE 201, LEXINGTON, KY, 40503, US

(73) Assignee: Dippin' Dots, Inc.

(21) Appl. No.: 11/256,389

(22) Filed: Oct. 21, 2005

Related U.S. Application Data
(60) Provisional application No. 60/624,016, filed on Nov. 1, 2004.

(51) Int. Cl. A23L 1/27; A23G 3/02; C12C 7/26; A23L 3/36

(52) U.S. Cl. 426/524; 426/249; 426/512; 426/515

(57) ABSTRACT

This invention relates generally to a sandwich made from particulate ice cream and wafers.

### CROSS-REFERENCE TO RELATED APPLICATIONS

This application claims priority to U.S. Provisional Application No. 60/624,016, which was filed on Nov. 1, 2004.

### FIELD OF THE INVENTION

The present invention relates to novel combinations of cryogenic ice cream products.

### BACKGROUND OF THE INVENTION

Cryogenically frozen ice cream can be sold in an increasing variety of forms. However, because the melting point of cryogenically frozen ice cream is higher than that of conventional ice cream, an edible product which need not be immediately consumed is desired.

### SUMMARY OF THE INVENTION

It is an object of the present invention to comprise a sandwich of which the main ingredient is cryogenically frozen particulate ice cream. It is another object of the present invention to configure this invention so that it can be quickly and easily assembled and stored. These and other objects and advantages of the invention will become readily apparent as the following description is read in conjunction with the accompanying drawings.

### BRIEF DESCRIPTION OF THE DRAWINGS

FIG. 1 is a plan view of the mechanism for manufacturing the beads used in the present invention;

FIG. 2 shows a form-cup used to package and manufacture the present invention;

FIG. 3 shows a wafer used within the present invention; and

FIG. 4 shows an exemplary embodiment of the present invention;

### DETAILED DESCRIPTION OF THE PREFERRED EMBODIMENTS

Before explaining the disclosed embodiment of the present invention in detail it is to be understood that the invention is not limited in its application to the details of the particular arrangement shown, since the invention is capable of other embodiments. Also, the terminology used herein is for the purpose of description and not of limitation.

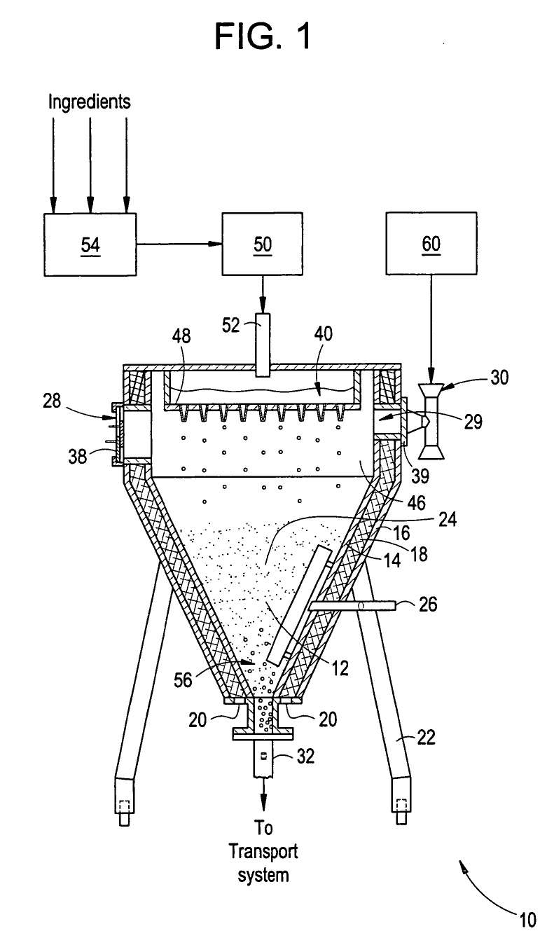

FIG. 1 shows a cryogenic processor constructed in accordance with the preferred embodiment of the present invention to produce free-flowing beads 56. The fundamental method utilized to produce the product is described in detail in U.S. Pat. No. 5,126,156, which is hereby incorporated by reference.

A cryogenic processor 10 includes a freezing chamber 12 that is most preferably in the form of a conical tank that holds a liquid refrigerant therein. A freezing chamber 12 incorporates an inner shell 14 and an outer shell 16. Insulation 18 is disposed between the inner shell 14 and outer shell 16 in order to increase the thermal efficiency of the chamber 12. Vents 20 are also provided to ventilate the insulated area formed between the shells 14 and 16. The freezing chamber 12 is a free-standing unit supported by legs 22.

A refrigerant 24, preferably liquid nitrogen, enters the freezing chamber 12 by means of refrigerant inlet 26. The refrigerant 24 is introduced into a chamber 12 through the inlet 26 in order to maintain a predetermined level of liquid refrigerant in the freezing chamber because some refrigerant 24 can be lost by evaporation or by other means incidental to production. Gaseous refrigerant that has evaporated from the surface of the liquid refrigerant 24 in freezing chamber 12 primarily vents to the atmosphere through exit port 29 which cooperates with the vacuum assembly 30, which can be in the form of a venturi nozzle. Extraction of the frozen beads occurs through product outlet 32 adapted at the base of the freezing chamber 12.

An ambient air inlet port 28 with adjustment doors 38 and exit port 29 with adjustment doors 39 are provided to adjust the level of gaseous refrigerant which evaporates from the surface of the liquid refrigerant 24 so that excessive pressure is not built up within the processor 10 and freezing of the liquid composition in the feed assembly 40 does not occur.

A feed tray 48 receives liquid composition from a delivery source 50. Typically, a pump (not shown) drives the liquid composition through a delivery tube 52 into the feed tray 48. A premixing device 54 allows several compositions, not all of which must be liquid, such as powdered flavorings or other additives of a size small enough not to cause clogging in the feed assembly 40, to be mixed in predetermined concentrations for delivery to the feed tray 48.

In order to create uniformly sized particulate or beaded ice cream 56, uniformly sized droplets of liquid composition are required to be fed through gas diffusion chamber 46 to freezing chamber 12. The feed tray 48 is designed with feed assembly 40 that forms droplets of the desired character. The frozen product takes the form of beads that are formed when the droplets 58 of liquid composition contact the refrigerant vapor in the gas diffusion chamber 46, and subsequently the liquid refrigerant 24 in the freezing chamber 12. After the particulate ice cream 56 is formed, they fall to the bottom of chamber 12. The particulate 56 may be in the form of beads, chunks, or other physical shapes. A transport system connects to the bottom of chamber 12 at outlet 32 to carry the particulate 56 to a packaging and distribution network for later delivery and consumption. the bowls will be handling the particulate ice cream 56 at room temperature for a short time. It is necessary to work quickly and not allow the particulate ice cream 56 to melt. The bowls having a lower temperature will assist in the avoiding of melting.

The assembler takes the bowls out of the freezer, and puts approximately five scoops of particulate ice cream 56 into the bowls. This amount could vary depending on the mixture of the flavors. Chocolate, mint chocolate and vanilla are three exemplary flavors of ice cream, although the present invention should not be considered as limited exclusively thereto. Also, there can be a variety of combinations of wafers and ice cream, such as chocolate wafer and mint chocolate particulate, chocolate chip wafer and cookie dough particulate, as well as chocolate wafer and vanilla particulate.

As stated, the present invention employs pre-packaged syrup containers that a user squeezes into the particulate ice cream 56. These containers are precalibrated to determine exactly how much syrup 404 an assembler requires to arrive at the correct ratio of syrup/particulate for the sandwich of the present invention, including but not limited to five scoops of particulate. These syrups act as a binding agent to keep the particulate ice cream 56 in position within the present invention, and also act to temporarily inhibit the melting process. As with the particulate ice cream 56, the syrups can also be a variety of flavors and compositions.

Using a spatula, the assembler continually directs all materials inward while stirring, until the particulate ice cream 56 is effectively mixed within the syrup. This portion of the process should take two minutes at most. It is important to not crush the particulate ice cream 56 with excessive agitation of the spatula. As stated, it is also important to work quickly as the particulate ice cream 56 melts quickly at room temperature.

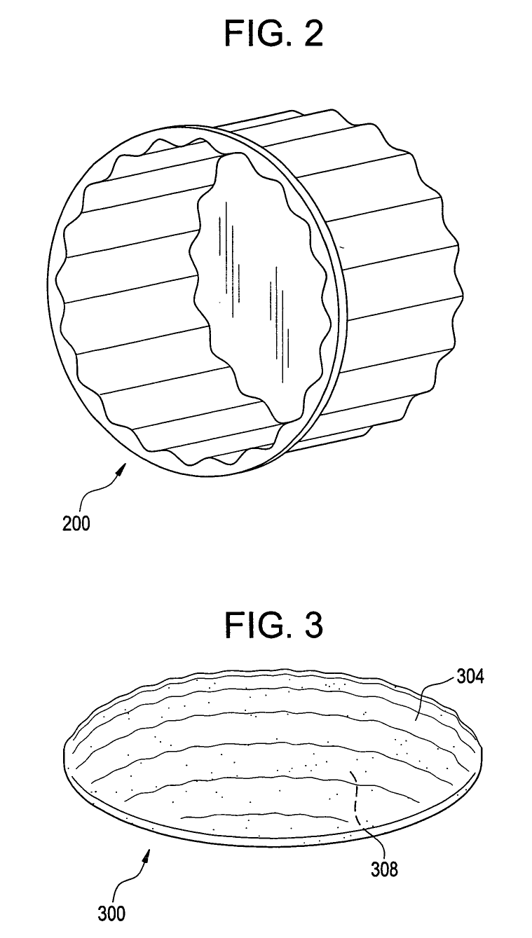

Another part of the present invention are small plastic cylindrical form-cups 200 (FIG. 2), which are cylindrical and not tapered. As shown in FIG. 2, these cylindrical cups are approximately 2 inches deep, and perhaps 4 inches in diameter, although exact dimensions can vary.

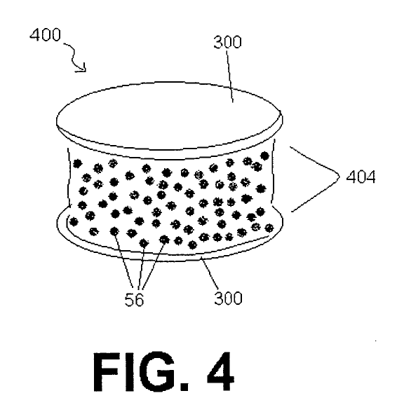

Along with the various flavors, a specific type of wafer 300 is formed to directly fit in the bottom of the form cup 200, as shown in FIGS. 3 and 4. The wafers 300 can come within a variety of flavors, and can have a rounded side 304 and a flat side 308, although other shapes are contemplated within the spirit and scope of the present invention.

Using a vanilla ice cream sandwich as an exemplary embodiment of the present invention, the assembler places a chocolate wafer 300 at the bottom of the form cup 200. If the wafer 300 has a rounded edge 304, that rounded edge should be facing downward. The assembler puts a wafer in the bottom of the form cup 200, takes the spatula and scoops up the interior mixture produced as described above, puts the mixture in the form cup 200 and levels it off to the top, and then puts the other wafer 300 on top. If the top wafer 300 has a rounded edge 304, that rounded edge should be facing upward. The assembler then places the lid (not shown) on the form cup 200, ensures the item is correctly labeled, and places in frozen storage.

The present invention must initially be placed in a freezer that can maintain temperatures of −40° F. However, immediately upon placement in storage, they are ready for sale to users, as they come with the labels. When they are first manufactured, the present invention must be placed within in a storage freezer at −400 ° F. However, after 4-6 hours at such temperature, the present invention could also be stored in a conventional serving freezer which has a higher ambient temperature, such as that in a typical home.

This is possible because the particulate ice cream 56 within the present invention holds its shape and resists melting because of the syrup which acts as a binding agent. The syrup 404 has a lower melting point than the particulate ice cream 56. Also, the syrup 404 increases the surface tension on the particulate ice cream 56, thereby helping the beads 56 remain looking like spheres rather than melting into blotches, even at higher temperatures where stand-alone beads 56 would normally melt. As shown in FIG. 4, in that embodiment the beads 56 still look like rounded spheres or dots.

An assembler would have difficulty making the particulate ice cream sandwich of the present invention without the form cups 200 because the core mixture would all ooze out from between the wafers 300. The form cup 200 assists the sandwich 400 in holding its cylindrical shape. Thus, the form cup 200 acts as a mould for forming the present invention as well as a container for holding it. As shown in FIG. 2. the form cups 200 are non-tapered cylinders, and thus have straight vertical and horizontal surfaces.

In making the ice cream sandwiches of the present invention, there are two things that the assembler must do. After forming the sandwich 400 but prior to freezing, the assembler must apply a label and remember to immediately put the ice cream sandwich in a storage freezer. If the assembler doesn't apply the label, it can be difficult to retroactively determine the specific flavor contained within the cup. Also, if the assembler doesn't quickly put the finished product in the specialized freezer at −40° F., the combination could melt.

The sandwich should be frozen in a storage freezer for at least six hours. Afterwards, it may be stored in a conventional freezer, or immediately consumed.

It is anticipated that various changes may be made in the arrangement and operation of the system of the present invention without departing from the spirit and scope of the invention, as described in the following claims.

What is claimed is:

1. An ice cream sandwich, comprising:
particulate ice cream;
a syrup to act as a binding agent to be combined with the particulate ice cream so as to assist the particulate ice cream in conforming to specific desired shape;
a form cup; and
an upper and lower wafer;
wherein the combination of particulate ice cream and syrup are located between said wafers while inside of said form cup, further wherein the entire combination is placed in a storage freezer set at not higher than −40° F. for at least six hours.

2. The sandwich of claim 1, further compromising:
said syrup keeps the sandwich cohesive and reduces dripping.

3. The sandwich of claim 1, further comprising:
said particulate ice cream can be either chocolate, mint chocolate or vanilla.

4. The sandwich of claim 1, further comprising:
said wafers are chocolate and said particulate is mint chocolate.

5. The sandwich of claim 1, further comprising:
said wafers are chocolate chip and said particulate is cookie dough.

6. The sandwich of claim 1, further comprising:
said wafers are chocolate and said particulate is vanilla.

7. The sandwich of claim 1, further compromising:
said syrup is located within pre-packaged syrup containers that a user squeezes into the particulate ice cream.

8. The sandwich of claim 7, further comprising:
said containers are pre-calibrated to correspond to a specific amount of particulate.

9. The sandwich of claim 1, further comprising:
during mixing of said particulate with said syrup, the particulate remains intact and is not crushed.

10. The sandwich of claim 1, further comprising:
said form-cups are plastic and cylindrical.

11. The sandwich of claim 10, further comprising:
said wafers are formed to directly fit in the bottom of said form cup.

12. A method of assembling an ice cream sandwich, comprising:
combining particulate ice cream with a binding syrup in predetermined proportions;
locating a wafer at the bottom of a form cup;
assuring a rounded edge of said wafer is facing downward;
scooping said combination into said form cup and leveling off to the top;
locating top wafer on top of above combination with rounded edge facing upward;
locating said combination within frozen storage.

13. The method of claim 12, further comprising:
placing a lid on said form cup.

14. The method of claim 13, further comprising:
applying a label to said lid.

15. The method of claim 14, further comprising:
maintaining said frozen storage at −40° F.

16. The method of claim 15, further comprising:
removing said combination from said frozen storage after 4-6 hours; and
storing said combination within a conventional serving freezer.

17. The method of claim 16, further comprising:
maintaining said conventional serving freezer at −5° F. to +10° F.

18. The method of claim 12, wherein said syrup has a higher melting point than the particulate ice cream.

19. The method of claim 12, wherein said syrup increases the surface tension on the particulate ice cream.

20. The method of claim 12, wherein said form cup causes said combination to hold its cylindrical shape and thereby acts as a mould for forming the sandwich as well as a container for holding it.

21. The method of claim 12, further comprising:
manufacturing said form cups to be non-tapered cylinders having straight vertical and horizontal surfaces.
